(19) United States
(12) Patent Application Publication
(10) Pub. No.: US 2026/0142699 A1
(43) Pub. Date: May 21, 2026

(54) WIRELESS COMMUNICATION DEVICE AND TRANSMIT ANTENNA SELECTION METHOD USING NON-CONTIGUOUS ANTENNA COMBINATIONS TO MANAGE NEAR-FIELD POWER DISTRIBUTION

(71) Applicant: MEDIATEK INC., Hsinchu City (TW)

(72) Inventors: Chih-Wei Chiu, Hsinchu City (TW); Yeh-Chun Kao, Hsinchu City (TW); Chih-Wei Lee, Hsinchu City (TW)

(73) Assignee: MEDIATEK INC., Hsinchu City (TW)

(21) Appl. No.: 19/382,230

(22) Filed: Nov. 6, 2025

Related U.S. Application Data
(60) Provisional application No. 63/722,120, filed on Nov. 19, 2024.

(51) Int. Cl. H04B 7/06

(52) U.S. Cl. CPC H04B 7/0617

(57) ABSTRACT

A method for selecting transmit antennas and a related wireless communication device are disclosed. The wireless communication device includes an antenna array with a plurality of antennas and a control circuit. The control circuit is coupled to the antenna array and is used to determine a predetermined number of the antennas to be used for transmitting a radio frequency (RF) signal. The control circuit is further used to select, according to the predetermined number, a corresponding number of the antennas to form an activated antenna combination. In the activated antenna combination, at least two selected antennas are separated by at least one unselected antenna along a primary arrangement direction of the antenna array.

### CROSS REFERENCE TO RELATED APPLICATIONS

This application claims the benefit of U.S. Provisional Application No. 63/722,120, filed on Nov. 19, 2024. The content of the application is incorporated herein by reference.

### BACKGROUND

With the development of 5th generation mobile networks (5G), the application of the millimeter-wave (mm-wave) frequency band, particularly frequency range 2 (FR2 ), is becoming increasingly widespread. Due to the high path loss of radio waves propagating through the air in the mm-wave band, mobile communication devices must adopt technologies with high antenna gain to ensure stable communication quality.

To this end, the industry commonly employs antenna arrays in conjunction with beamforming technology. Beamforming technology concentrates the transmitted electromagnetic energy into a specific narrow angular range by controlling the signal phase and amplitude of multiple antennas in an antenna array, thereby forming a directional high-gain beam. This approach effectively enhances the transmission distance and quality of the signal and significantly improves the device's effective isotropic radiated power (EIRP).

However, the energy concentration characteristic of beamforming technology also presents challenges in complying with the electromagnetic radiation regulations of various countries. For instance, regulatory bodies such as the U.S. Federal Communications Commission (FCC) impose strict limits on the near-field power emission of mobile devices to protect human safety. The regulations typically require measuring the average power density over a specific area (e.g., 2 cm×2 cm) at a location very close to the surface of the antenna array and ensuring that its value does not exceed the regulatory limit.

In conventional transmit antenna selection mechanisms, when the system needs to activate a plurality of antennas to form a beam, it usually selects a set of physically adjacent or contiguous antennas to be activated simultaneously. Although this practice helps form a well-focused far-field beam, its highly concentrated energy characteristic can easily create a “hotspot” with excessive power density in the near-field region in front of the antenna array, thus violating regulatory limits.

To address this issue, existing technical solutions involve directly reducing the overall output power of the radio frequency integrated circuit (RFIC) when the near-field power density is detected to potentially exceed the limit, thereby lowering the average power density within the measurement area to a compliant level. However, this approach of reducing the overall transmission power directly weakens the strength of the far-field beam, leading to a degradation of the device's EIRP performance and signal coverage. This creates a fundamental conflict between meeting regulatory requirements and maintaining optimal communication performance.

Therefore, how to maximize the EIRP and signal coverage of a communication device while satisfying strict near-field power emission regulations has become a significant technical challenge in the current field of mm-wave antenna array design.

### SUMMARY

An embodiment of the present invention provides a method for selecting antennas of a wireless communication device. The wireless communication device comprises an antenna array, and the antenna array comprises a plurality of antennas. The method comprises determining a predetermined number of the antennas to be used for transmitting a radio frequency (RF) signal; and selecting, according to the predetermined number, a corresponding number of the antennas to form an activated antenna combination. In the activated antenna combination, at least two selected antennas are separated by at least one unselected antenna along a primary arrangement direction of the antenna array.

Another embodiment of the present invention provides a wireless communication device. The wireless communication device comprises an antenna array and a control circuit. The antenna array comprises a plurality of antennas. The control circuit is coupled to the antenna array and is configured to determine a predetermined number of the antennas to be used for transmitting a radio frequency (RF) signal. The control circuit is further configured to select, according to the predetermined number, a corresponding number of the antennas to form an activated antenna combination. In the activated antenna combination, at least two selected antennas are separated by at least one unselected antenna along a primary arrangement direction of the antenna array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a wireless communication device according to an embodiment of the present invention.

FIG. 2 is a physical layout diagram illustrating an antenna module in FIG. 1.

FIG. 3 is a schematic diagram illustrating an antenna selection method according to an embodiment of the present invention.

FIG. 4 is a diagram illustrating a near-field power radiation distribution generated by adopting the antenna selection method of FIG. 3.

FIG. 5 is a comparison chart illustrating the effective isotropic radiated power (EIRP) performance between the antenna selection method of the present invention and the prior art.

### DETAILED DESCRIPTION

To describe the present invention in detail, embodiments are provided with reference to the drawings. Those skilled in the art will understand that the following embodiments are for illustrative purposes only and are not intended to limit the scope of the present invention. Furthermore, for the sake of brevity, well-known components may be omitted from the drawings.

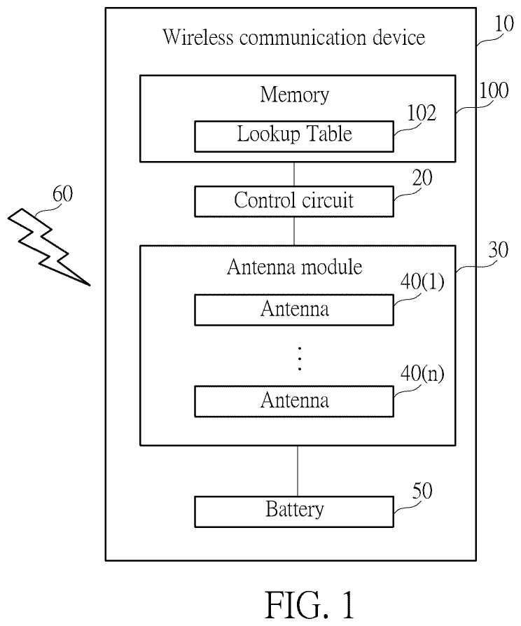

Please refer to FIG. 1, which illustrates a functional block diagram of a wireless communication device 10 according to an embodiment of the present invention. The wireless communication device 10 may be a smartphone, a tablet computer, a laptop computer, an Internet of Things (IoT) device, a wearable device, or any other electronic device equipped with wireless communication capabilities.

In this embodiment, the wireless communication device 10 comprises a control circuit 20, an antenna module 30, and a battery 50. The battery 50 is electrically coupled to the control circuit 20 and the antenna module 30 to provide the necessary power for the operation of the wireless communication device 10. The antenna module 30 includes a plurality of antennas 40(1) to 40(n), where n is a positive integer greater than 2. These antennas 40(1) to 40(n) collectively form an antenna array for transmitting and/or receiving a radio frequency (RF) signal 60.

The control circuit 20 is coupled to the antenna module 30 and is configured to control the overall operation of the wireless communication device 10. In some embodiments, the control circuit 20 may be implemented as a system-on-chip (SoC), a digital signal processor (DSP), a microcontroller unit (MCU), an application-specific integrated circuit (ASIC), or a field-programmable gate array (FPGA). The control circuit 20 is configured to execute the transmit antenna selection method disclosed in the present invention. In some embodiments, the method may be implemented as firmware or software stored in a memory, and executed by the control circuit 20 (e.g., a baseband processor therein).

Specifically, during a transmission (TX) operation, the control circuit 20 determines the number of antennas to be activated based on a specific communication scenario (e.g., target communication performance, power consumption constraints, or thermal conditions), and selects a specific activated antenna combination from the antennas 40(1) to 40(n). Subsequently, the control circuit 20 outputs a control signal to the antenna module 30, causing the antenna module 30 to transmit the RF signal 60 only through the antennas in the activated antenna combination. As will be detailed in subsequent embodiments, the activated antenna combination selected by the control circuit 20 is characterized in that the selected antennas are not entirely contiguous in their physical arrangement, so as to disperse the near-field power radiation generated by the antenna module 30.

In one embodiment, as shown in FIG. 1, a memory 100 is coupled to the control circuit 20 and stores a lookup table (LUT) 102. The control circuit 20 makes its selection based on this pre-established lookup table 102. This lookup table 102 is created during the design or manufacturing stage of the wireless communication device 10 through electromagnetic simulation software or actual RF measurements. Specifically, various non-contiguous activated antenna combinations are iteratively calculated for a plurality of possible operating scenarios (e.g., requiring the activation of two, three, four, or more antennas; different target beam directions; different operating frequency bands, etc.). For each combination, the system simultaneously evaluates whether its near-field power radiation distribution complies with regulatory requirements and the performance of the far-field effective isotropic radiated power (EIRP) it generates. Finally, for each operating scenario, only those antenna combinations that can produce the optimal or sub-optimal EIRP performance while complying with near-field regulations are recorded in the lookup table 102. In this way, when the wireless communication device 10 is in actual operation, the control circuit 20 only needs to quickly query and apply the corresponding optimal activated antenna combination from the lookup table 102 based on the current operating scenario, without performing complex real-time computations.

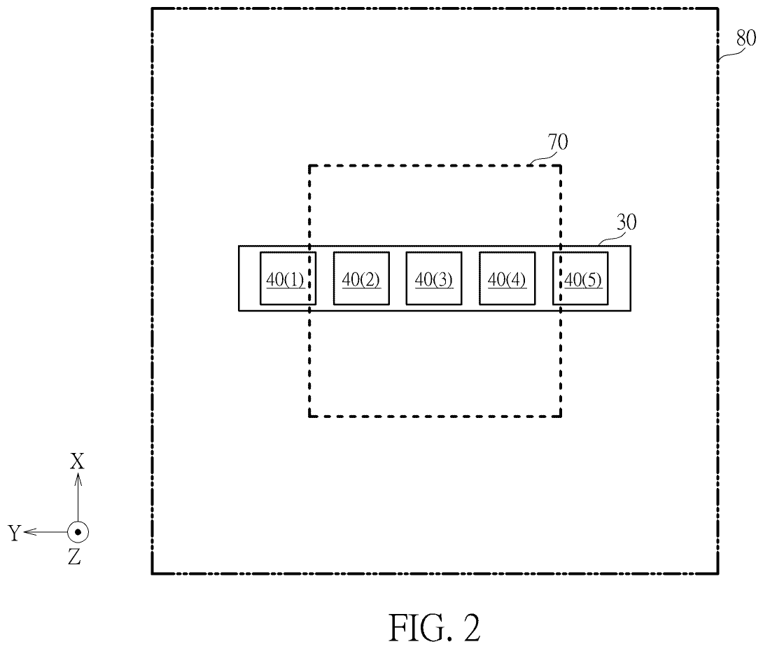

Please refer to FIG. 1 and FIG. 2 simultaneously. FIG. 2 illustrates a physical layout diagram of the antenna module 30 in FIG. 1. In this embodiment, the total number of antennas n is 5, meaning the antenna module 30 comprises antennas 40(1) to 40(5), which are arranged at uniform spacing along the Y-axis direction to collectively form a linear antenna array. This Y-axis direction is an extension direction of the linear antenna array and can also be considered a primary arrangement direction of the antenna array. However, the present invention is not limited thereto. In other embodiments, the total number of antennas n can be any positive integer greater than 2, and the arrangement of the antennas can also be non-uniform spacing or other layout forms.

FIG. 2 also illustrates two schematic areas related to near-field power emission regulations. The inner dashed box represents a regulatory average power density measurement area 70. This area 70 defines a specific area (e.g., 2 cm by 2 cm, i.e., 4 square cm, according to U.S. FCC regulations) used for calculating the average power density within this area and comparing it with the upper limit set by the regulations. The outer dotted-dashed box represents a near-field power radiation scanning area 80. During actual simulation or measurement, a comprehensive power distribution scan is performed on this larger scanning area 80 on a plane at a predetermined distance (e.g., 2 mm) from the antenna module 30. Then, the system or measuring instrument moves the regulatory average power density measurement area 70 within this scanning area 80 to find the “worst-case” position that produces the highest average power density. The average power density value at that position is the basis for determining compliance with the regulations.

As described in the prior art, the conventional method of continuously activating adjacent antennas tends to cause excessive energy concentration, leading to the calculated average power density value within the regulatory average power density measurement area 70 exceeding the specification.

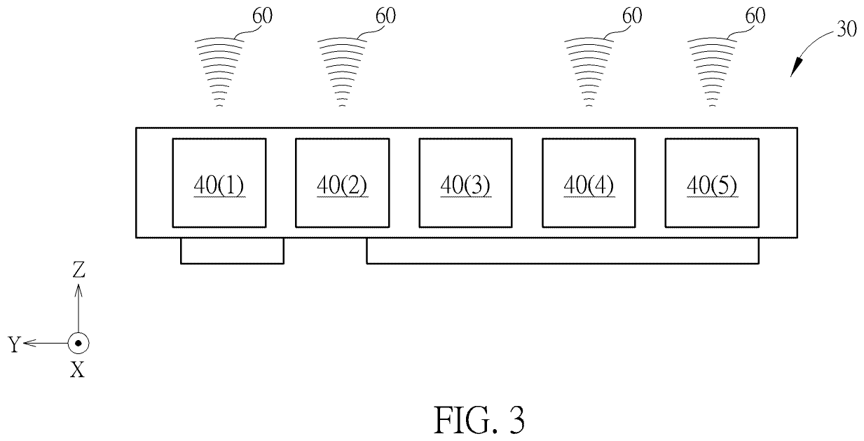

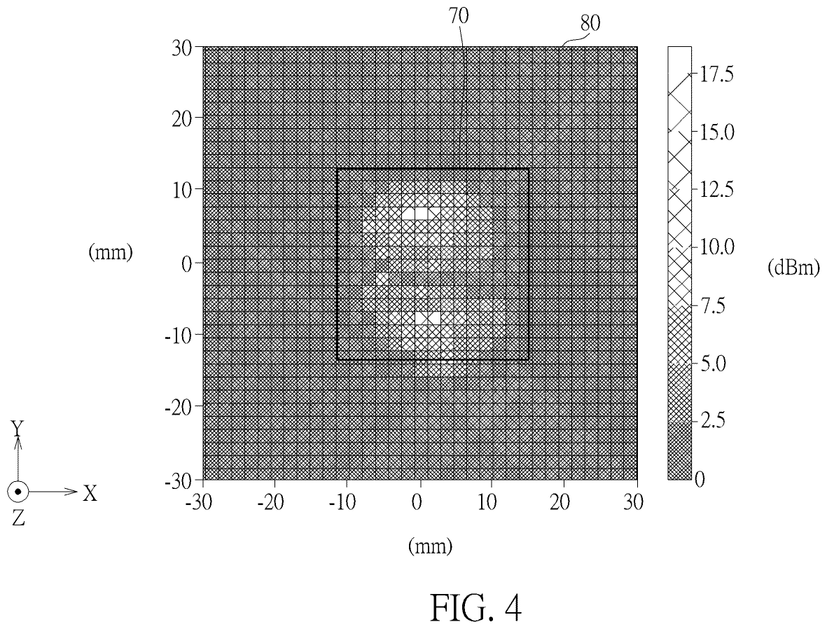

Please further refer to FIG. 3 and FIG. 4. FIG. 3 is a schematic diagram illustrating a transmit antenna selection method according to an embodiment of the present invention, and FIG. 4 is a diagram of the near-field power radiation distribution generated after adopting the antenna selection method of FIG. 3.

In this embodiment, it is assumed that the control circuit 20 (shown in FIG. 1) determines that four antennas need to be activated for a transmission operation. Unlike the prior art which selects four contiguous antennas, as shown in FIG. 3, the control circuit 20 selects a non-contiguous activated antenna combination. Specifically, the activated antenna combination includes antennas 40(1), 40(2), 40(4), and 40(5), while the central antenna 40(3) is intentionally kept in an inactive or unexcited state. This non-contiguous selection can be regarded as splitting the four antennas into two physically separated sub-arrays: a first sub-array formed by antennas 40(1) and 40(2), and a second sub-array formed by antennas 40(4) and 40(5). As shown in FIG. 4, these two separate sub-arrays each contribute an energy concentration zone, thereby effectively dispersing a single near-field power hotspot into two (or more) hotspots with lower energy.

Please refer to FIG. 4, which shows the power distribution measured within the near-field power radiation scanning area 80 after adopting the aforementioned non-contiguous antenna selection method. It can be clearly observed from the figure that since antenna 40(3) does not transmit energy, the energy originally concentrated in the center is effectively dispersed, forming two main energy concentration zones. One energy concentration zone is primarily contributed by antennas 40(1) and 40(2) located on one side of the antenna array, while the other energy concentration zone is contributed by antennas 40(4) and 40(5) on the opposite side.

When we place the regulatory average power density measurement area 70 within the scanning area 80 to find the worst-case scenario, the total energy enclosed by any single position of the measurement area 70 is significantly lower than in the case of highly concentrated energy in the prior art, because the energy has been dispersed. This allows the average power density calculated within the measurement area 70 to easily meet the regulatory requirements.

Therefore, the antenna selection method of the present invention successfully breaks up the concentrated near-field energy “hotspot” by strategically creating a “gap” in the activated antenna combination. This enables the wireless communication device 10 to maintain or even increase the overall output power of the radio frequency integrated circuit (RFIC) without violating near-field power emission regulations, thereby avoiding the problem in the prior art where far-field communication performance had to be sacrificed for regulatory compliance.

Furthermore, when selecting the activated antenna combination, the control circuit 20 of the present invention not only considers the dispersion of near-field power but also takes into account the performance of far-field beamforming. The quality of far-field beamforming is closely related to the effective spacing between the antennas, and this spacing is typically designed based on the wavelength of the RF signal 60. To form a well-focused, high-gain far-field beam, the spacing between the activated antennas should not be excessively large. Therefore, the control circuit 20 will select a combination that can both disperse near-field energy and maintain the effective spacing between the two selected antennas that are adjacent to the at least one unselected antenna within a predetermined wavelength range (e.g., between 0.3 and 0.8 wavelengths of the RF signal 60). Within this range, a spacing of approximately half a wavelength of the RF signal 60 is known to provide the best performance for far-field beamforming. This avoids far-field beam splitting or the generation of excessive side lobes due to overly large spacing, thereby ensuring overall communication quality.

It should be noted that the embodiment shown in FIG. 3 is merely exemplary. In other scenarios requiring the activation of a different number of antennas, the control circuit 20 can adopt a similar non-contiguous selection logic. For instance, if the communication scenario requires activating three antennas, the control circuit 20 may select a combination such as antennas {40(1), 40(3), and 40(5)} to disperse energy by creating uniform spacing between the activated antennas. Alternatively, a combination such as {40(1), 40(2), and 40(4)} could be selected. If only two antennas are required, instead of conventionally selecting an adjacent pair like {40(1) and 40(2)}, the control circuit 20 can select any non-adjacent combination, such as {40(1) and 40(3)}, {40(2) and 40(4)}, or {40(1) and 40(5)}. Among these options, selecting the combination of {40(2) and 40(4)} effectively disperses energy towards the ends of the antenna array while maintaining far-field performance, thereby managing the near-field power distribution. The spirit of the present invention is, therefore, the utilization of selective antenna combinations to actively and intelligently manage the near-field power distribution.

Furthermore, the control circuit 20 can enhance the selection of the activated antenna combination by considering the individual performance of each antenna and its surrounding physical environment. For example, if antenna 40(1) exhibits poor radiation efficiency due to its proximity to a metal frame, the selection logic adapts accordingly. If four antennas still need to be activated, the control circuit 20 may prioritize avoiding the inefficient antenna 40(1) and instead select a non-contiguous combination from the set of better-performing antennas, such as activating {40(2), 40(4), and 40(5)} from the set {40(2), 40(3), 40(4), 40(5)}. If the scenario required only three antennas, the control circuit 20 could select a non-contiguous combination from the set of better-performing antennas, such as {40(2), 40(4), and 40(5)}, to further optimize performance. This intelligent selection, based on pre-stored performance data, ensures that the present invention maximizes actual communication performance while maintaining regulatory compliance.

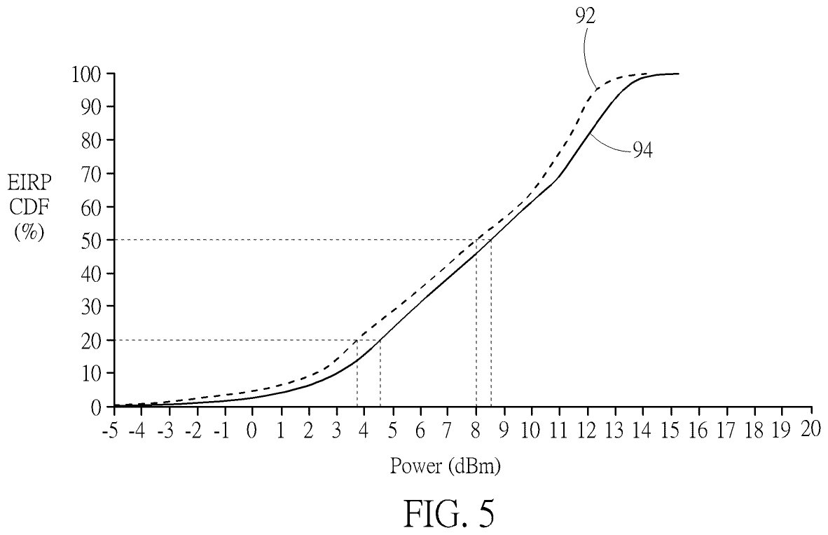

Please refer to FIG. 5, which illustrates a comparison chart of the effective isotropic radiated power (EIRP) performance between the antenna selection method of the present invention and the prior art. This chart is a cumulative distribution function (CDF) plot of EIRP, where the horizontal axis represents the EIRP power level in dBm, and the vertical axis represents the CDF percentage, indicating the proportion of all measurement directions in which the EIRP value is less than or equal to the corresponding power level on the horizontal axis.

In the figure, the dashed curve 92 represents the performance distribution obtained using the prior art's contiguous antenna selection method, while the solid curve 94 represents the EIRP performance distribution obtained using the non-contiguous antenna selection method of the present invention (as shown in FIG. 3).

It can be clearly seen from the figure that, over the entire CDF percentage range, the solid curve 94 representing the present invention is consistently to the right of the dashed curve 92 representing the prior art. This indicates that at any given coverage percentage, the EIRP power level achievable by the method of the present invention is higher than that of the prior art. This result confirms that the present invention can effectively enhance far-field communication performance without reducing the overall output power to comply with near-field regulations.

For example, at the 50% position on the vertical axis (which typically represents average performance), the power level corresponding to the dashed curve 92 is approximately 8 dBm, whereas the power level corresponding to the solid curve 94 is increased to approximately 8.5 dBm, showing an improvement in performance for medium coverage ranges. More significantly, at lower percentage positions on the vertical axis (e.g., 20%, representing the coverage edge areas with weaker signals), the performance gain brought by the present invention is even more pronounced.

Overall, the data in FIG. 5 demonstrates that the antenna selection method of the present invention, by intelligently dispersing the near-field power distribution, successfully avoids the problem in the prior art of sacrificing communication performance for regulatory compliance. Consequently, it enhances the overall EIRP performance of the wireless communication device, improving signal coverage and communication quality.

It should be understood that the foregoing embodiments are for illustration only and are not intended to limit the scope of the present invention. The physical arrangement of the antennas of the present invention is not limited to uniform spacing; the present invention is also applicable to antenna arrays with non-uniform spacing, and its selection logic can take the actual physical spacing into account to find the optimal combination.

Furthermore, the “gap” within the activated antenna combination, which is formed by the unselected antenna or antennas, may vary in size. For instance, in a hypothetical scenario involving a one-dimensional array with eight antennas arranged sequentially, if the control circuit 20 determines that four antennas should be activated, it may select a combination such as the first, second, fifth, and sixth antennas. This selection intentionally leaves the third and fourth antennas inactive, thereby creating a larger, contiguous gap in the central region of the antenna array. A larger gap, spanning the positions of two or more adjacent antennas, can disperse the near-field power even more effectively.

The applicability of the disclosed antenna selection method extends to more complex antenna array configurations, including multi-band or multi-polarization arrays. For example, in a multi-band system, the control circuit 20 can be configured to select the optimal antenna combination from a pre-stored database according to the current operating frequency band, as different frequencies correspond to different signal wavelengths. Accordingly, any variation that utilizes the fundamental approach of selecting a non-contiguous activated antenna combination to actively manage near-field power distribution is intended to fall within the protection scope of the present invention.

In summary, the disclosed antenna selection method introduces strategic gaps within an activated antenna combination to disperse near-field power radiation. This allows the RF front-end to operate at a higher power level without violating radiation regulations, thereby overcoming a key limitation of prior art methods. Consequently, the method improves far-field communication performance by enhancing Effective Isotropic Radiated Power (EIRP), expanding signal coverage, and improving overall communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for selecting antennas of a wireless communication device, the wireless communication device comprising an antenna array, the antenna array comprising a plurality of antennas, the method comprising:
determining a predetermined number of the antennas to be used for transmitting a radio frequency (RF) signal; and
selecting, according to the predetermined number, a corresponding number of the antennas to form an activated antenna combination;
wherein, in the activated antenna combination, at least two selected antennas are separated by at least one unselected antenna along a primary arrangement direction of the antenna array.

2. The method of claim 1, wherein an effective spacing between two of the selected antennas adjacent to the at least one unselected antenna is maintained within a predetermined wavelength range of the RF signal.

3. The method of claim 2, wherein the predetermined wavelength range is between 0.3 and 0.8 wavelengths of the RF signal.

4. The method of claim 3, wherein the effective spacing is half a wavelength of the RF signal.

5. The method of claim 1, wherein the number of the at least one unselected antenna is one.

6. The method of claim 1, wherein the step of selecting the activated antenna combination is based on a pre-stored lookup table, the lookup table storing a plurality of activated antenna combinations respectively corresponding to different communication scenarios.

7. The method of claim 1, wherein the antenna array is a linear array, and the primary arrangement direction corresponds to an extension direction of the linear array.

8. A wireless communication device, comprising:
an antenna array, comprising a plurality of antennas; and
a control circuit, coupled to the antenna array, the control circuit being configured to:
determine a predetermined number of the antennas to be used for transmitting a radio frequency (RF) signal; and
select, according to the predetermined number, a corresponding number of the antennas to form an activated antenna combination;
wherein, in the activated antenna combination, at least two selected antennas are separated by at least one unselected antenna along a primary arrangement direction of the antenna array.

9. The wireless communication device of claim 8, wherein an effective spacing between two of the selected antennas adjacent to the at least one unselected antenna is maintained within a predetermined wavelength range of the RF signal.

10. The wireless communication device of claim 9, wherein the predetermined wavelength range is between 0.3 and 0.8 wavelengths of the RF signal.

11. The wireless communication device of claim 10, wherein the effective spacing is half a wavelength of the RF signal.

12. The wireless communication device of claim 8, wherein the number of the at least one unselected antenna is one.

13. The wireless communication device of claim 8, further comprising a memory coupled to the control circuit, wherein the control circuit is configured to select the activated antenna combination from a lookup table stored in the memory.

14. The wireless communication device of claim 8, wherein the antenna array is a linear array, and the primary arrangement direction corresponds to an extension direction of the linear array.
